(19) United States
(12) Patent Application Publication
(10) Pub. No.: US 2006/0061789 A1
(43) Pub. Date: Mar. 23, 2006

(54) Image forming apparatus and image forming method

(75) Inventors: Toyoaki Yamaoka, Mishima-shi (JP); Noboru Ogino, Mishima-shi (JP)

Correspondence Address: SoCAL IP LAW GROUP LLP, 310 N. WESTLAKE BLVD. STE 120, WESTLAKE VILLAGE, CA, 91362, US

(73) Assignees: Kabushiki Kaisha Toshiba, Minato-ku (JP); Toshiba Tec Kabushiki Kaisha, Chiyoda-ku (JP)

(21) Appl. No.: 10/945,744

(22) Filed: Sep. 20, 2004

(51) Int. Cl. G06F 3/12

(52) U.S. Cl. 358/1.13

(57) ABSTRACT

At a timing of opening properties of a printer driver, a terminal device sends an inquiry to a connected printer. The terminal device receives a response from the printer and executes comparison of the versions of the printer driver. If the version that is received from the printer is the later one, the terminal device causes a display unit to display a message that prompts update. If “UPDATE” is selected, the terminal device updates the printer driver using the printer driver that is stored in the printer.

### BACKGROUND OF THE INVENTION

1. Field of the Invention

The present invention relates to an image forming apparatus, such as a printer or a digital multi-function peripheral, which is connected to a network and effects printing, and to an image forming method.

2. Description of the Related Art

In the prior art, there is known a system wherein a printer that serves as an image forming apparatus is connected to a network, and printing can be effected from a plurality of terminal devices (e.g. personal computers).

In such a printer, an ordinary printer driver update function is as disclosed in Jpn. Pat. Appln. KOKAI Publication No. 2001-282511.

The outline of the configuration of the system is described.

A printer driver is installed in the terminal device.

The printer includes a version information storage unit that stores printer driver version information; an output instruction receiving unit that receives printer driver version information, which is sent from the terminal device; a version comparison unit that compares version information, which is sent from the terminal device, with version information, which is stored in the version information storage unit; and a version information notification unit that notifies the terminal device of a printer driver version on the basis of a comparison result by the version comparison unit.

Assume now that a plurality of terminal devices and a plurality of printers, as described above, are connected to the network.

In this system configuration, the operation of one of the printers is described.

1. The output instruction receiving unit receives print information from one terminal device.

2. Subsequently, the version comparison unit executes comparison of version information that is added to the received print information.

3. If the comparison result indicates that the received version information is the earlier one, the version information notification unit notifies the terminal device of the version information.

4. If the received version information is the later one, the version information is updated and the version information notification unit notifies the other terminal devices and printers of the version information.

In the above-described operation, however, the version information of the printer driver is embedded in the print information that is sent from the terminal device. Unless an actual printing operation is executed, comparison of driver version information cannot be carried out.

A latest printer driver that is not available in the same network environment needs to be manually installed. Automatic installation cannot be executed.

Assume that version 1.1 is the latest one of the printer driver in the network environment where the printer is used. In this case, if the vendor releases a printer driver version 1.2, the version 1.2 needs to be manually installed in the terminal devices in the network environment where the printer is used.

### BRIEF SUMMARY OF THE INVENTION

The object of an aspect of the present invention is to provide an image forming apparatus and an image forming method, which can support automatic installation of a latest printer driver when it is released.

According to an aspect of the present invention, there is provided an image forming apparatus that is connected to a plurality of terminal devices via a communication line and forms an image, comprising: storage means for storing a driver that drives the image forming apparatus, and driver information including version information of the driver; first control means for executing a control to send the version information of the driver, which is stored in the storage means, to the terminal device, when a version information transmission request that is sent from the terminal device is received; and second control means for executing a control to send the driver information, which is stored in the storage means, to the terminal device, when an update request is received from the terminal device in accordance with the version information of the driver that is sent by the control of the first control means.

According to another aspect of the present invention, there is provided an image forming method for an image forming apparatus that is connected to a plurality of terminal devices via a communication line and forms an image, the method comprising: storing a driver that drives the image forming apparatus, and driver information including version information of the driver; sending the stored version information of the driver to the terminal device, when a version information transmission request that is sent from the terminal device is received; and sending the stored driver information to the terminal device, when an update request is received from the terminal device.

Additional objects and advantages of an aspect of the invention will be set forth in the description which follows, and in part will be obvious from the description, or may be learned by practice of the invention. The objects and advantages of an aspect of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently preferred embodiments of the invention, and together with the general description given above and the detailed description of the embodiments given below, serve to explain the principles of an aspect of the invention.

FIG. 1 shows an example of the configuration of a system wherein a printer according to a first embodiment of an image forming apparatus of the present invention is connected;

FIG. 2 is a flow chart illustrating an operation that is executed between a terminal device and a printer;

FIG. 3 shows an example of MIB information that is sent from the printer to the terminal device;

FIG. 4 shows an example of a message that is displayed on a display unit to prompt updating;

FIG. 5 shows an example of the configuration of a system wherein a printer is connected;

FIG. 6 is a flow chart illustrating an operation of the printer; and

FIG. 7 shows an example of information that is transmitted between the printer and a Web server.

### DETAILED DESCRIPTION OF THE INVENTION

Embodiments of the present invention will now be described with reference to the accompanying drawings.

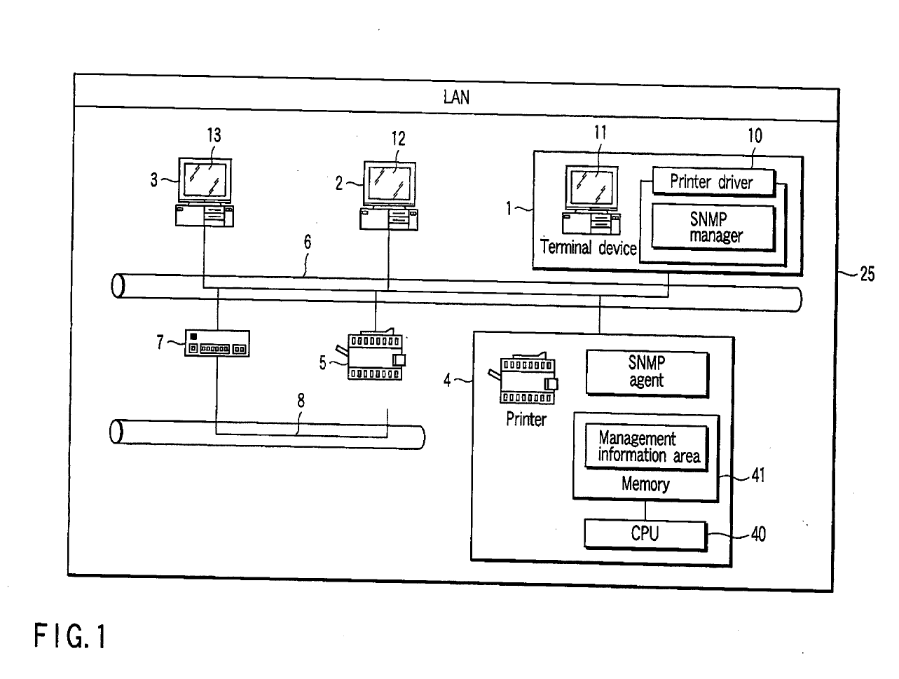

FIG. 1 shows an example of the configuration of a system wherein a printer according to a first embodiment of an image forming apparatus of the present invention is connected. In this system, terminal devices 1, 2 and 3, such as personal computers, and printers 4 and 5 are connected to a bus 6. Another bus 8 is connected to the bus 6 via a hub 7. The terminal devices 1, 2 and 3 have display units 11, 12 and 13 as display means, respectively.

The printer 4 includes a CPU 40 for executing an overall control, and a rewritable memory 41. As will be described later in detail, the memory 41 includes a management information area 16 that stores a printer driver and driver information including version information of the printer driver.

The above-described system configuration constitutes a local area network (LAN) 15.

The present system uses SNMP (Simple Network Management Protocol) that is a protocol for monitoring/controlling, via a network, communication devices that are connected to the network. Each of the printer driver and the printer has an MIB (Management Information Base) that is a management information database, thereby realizing two-way communication between each client and the printer. Thus, the version of the printer driver in the terminal device is managed.

In FIG. 1, a printer driver 10 that is installed in the terminal device 1 is made to operate as an SNMP manager, and the printer 4 is made to operate as an SNMP agent.

Each of the terminal devices 2 and 3 has the same structure as the terminal device 1, and the printer 5 has the same structure as the printer 4.

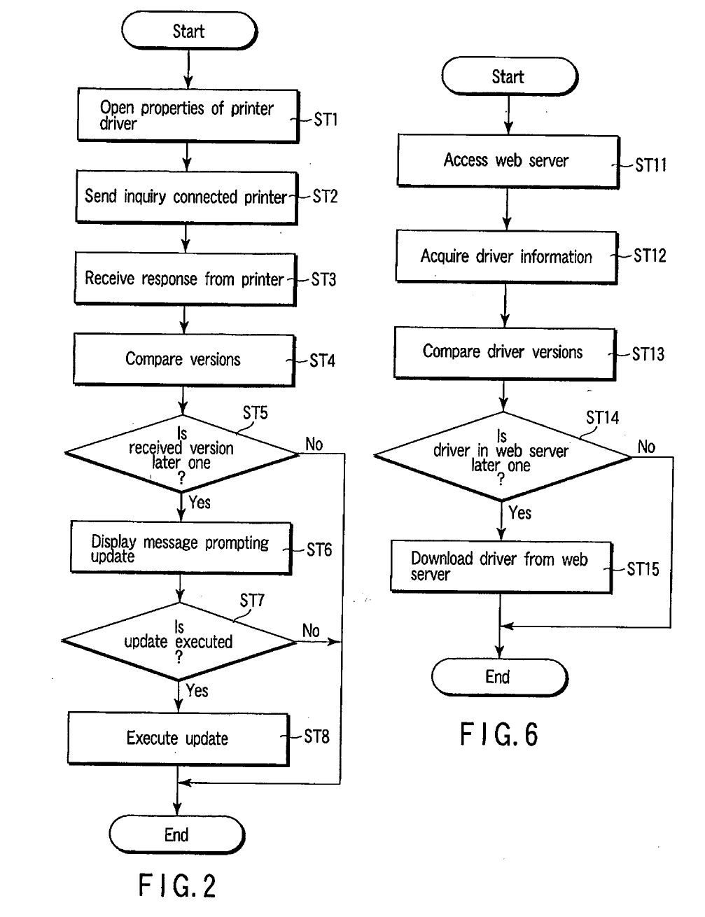

Referring now to a flow chart of FIG. 2, a description is given of an operation that is executed between the terminal device 1 and the printer 4 in the above-described configuration.

To start with, the user inputs an IP address or a DNS name of the printer 4 that is used for the printer driver 10 of the terminal device 1. This secures communication with the printer 4.

At a timing of opening properties of the printer drivers 10, the terminal device 1 sends an inquiry to the connected printer 4 (ST1, ST2).

In response to the inquiry, the CPU 40 of the printer 4 sends MIB information (including version information) to the terminal device 1.

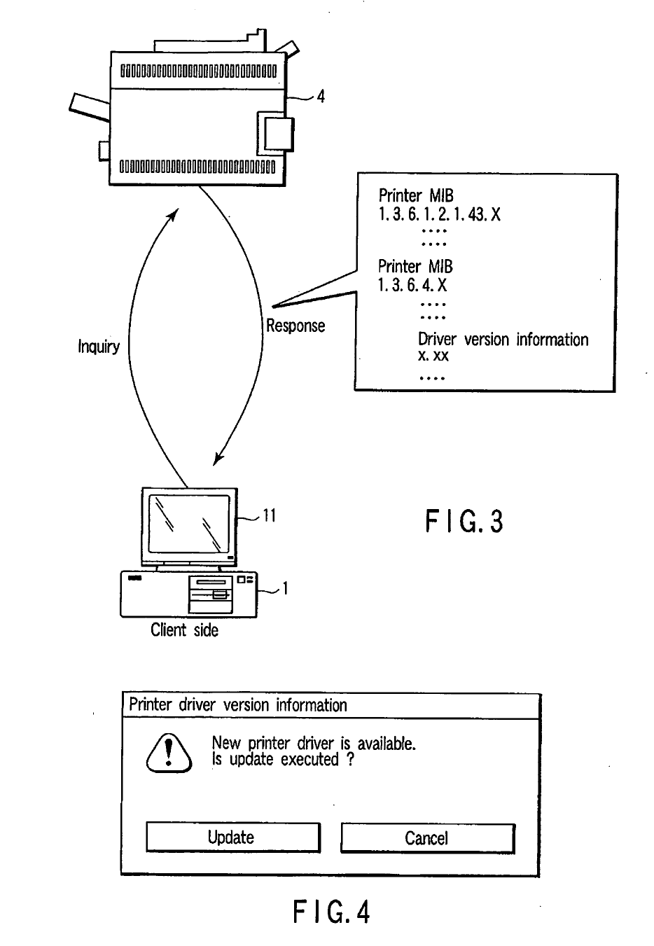

FIG. 3 shows an example of MIB information that is sent from the printer 4 to the terminal device 1. Examples of the response are Printer MIB “1.3.6.1.2.1..43.X”, Private MIB “1.3.6.1.4.X”.

The terminal device 1 receives a response from the printer 4 (ST3) and executes comparison of versions of the printer driver 10 (ST4).

If the version that is received from the printer 4 is the later one (ST5), the terminal device 1 causes the display unit 11 to display a message that prompts update (ST6).

FIG. 4 shows an example of the message that prompts update, which is displayed on the display unit 11.

If “UPDATE” is selected (ST7), the terminal device 1 updates the printer driver using the printer driver that is stored in the printer 4 (STB). In this case, the CPU 40 of the printer 4 sends the printer driver information to the terminal device 1 in response to an update request from the terminal device 1.

In step ST5, if the version received from the printer 4 is the same as that in the terminal device 1, the process is finished.

The above-described operation presupposes that the printer driver in the printer is the latest one on the network. In other words, it is necessary that the printer driver in the printer needs to be always the latest one. Thus, the printer is connected to the Internet environment and caused to periodically access a specified Web server (e.g. vendor's homepage). Thereby, the printer driver in the printer is automatically updated to the latest one.

Next, a second embodiment is described.

In this embodiment, in the case where the printer is connected to the Internet environment, the printer periodically accesses a specified Web server (e.g. vendor's homepage). Thereby, the printer driver in the printer is automatically updated to the latest one. In the case where the printer is connected to an intranet environment, the printer is connected to the Internet environment via a proxy server.

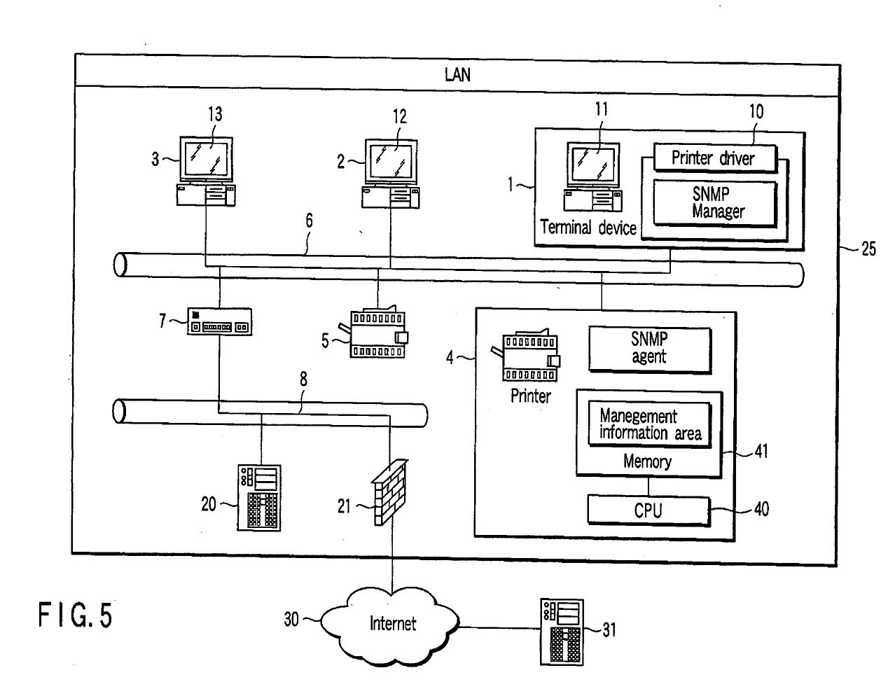

FIG. 5 shows an example of the configuration of a system wherein a printer according to the second embodiment is connected. The structural parts common to those in the first embodiment are denoted by like reference numerals, and a description is omitted.

In the present system, a local area network (LAN) 25 is constructed such that a proxy server 20 and a firewall 21 are connected to the bus 8 having the structure of the first embodiment. The LAN 25 is connected to the Internet 30 via the firewall 21. A Web server 31 is connected to the Internet 30.

Referring now to a flow chart of FIG. 6, the operation of the printer 4 having the above structure is described.

To start with, the printer 4 is connected to the Internet 30 (or connected via the proxy server 20 to the Internet 30 in the case of the intranet environment).

The CPU 40 of the printer 4 periodically accesses the specified Web server (e.g. vendor's homepage) 31 (ST11), and acquires latest driver information (version) from the Web server 31 (ST12).

The CPU 40 compares the acquired latest driver information (version) with the version of the printer driver in the printer (ST13).

If the driver information acquired from the Web server 31 is the later one (ST14), the CPU 40 downloads the printer driver from the Web server 31 (ST15).

In step S14, if the acquired latest driver information (version) is the same as the version of the printer driver in the printer, the CPU 40 finishes the process.

In the case where the CPU 40 periodically accesses the Web server in step ST11, the access interval is, for instance, once a day, once a weak, or once a month.

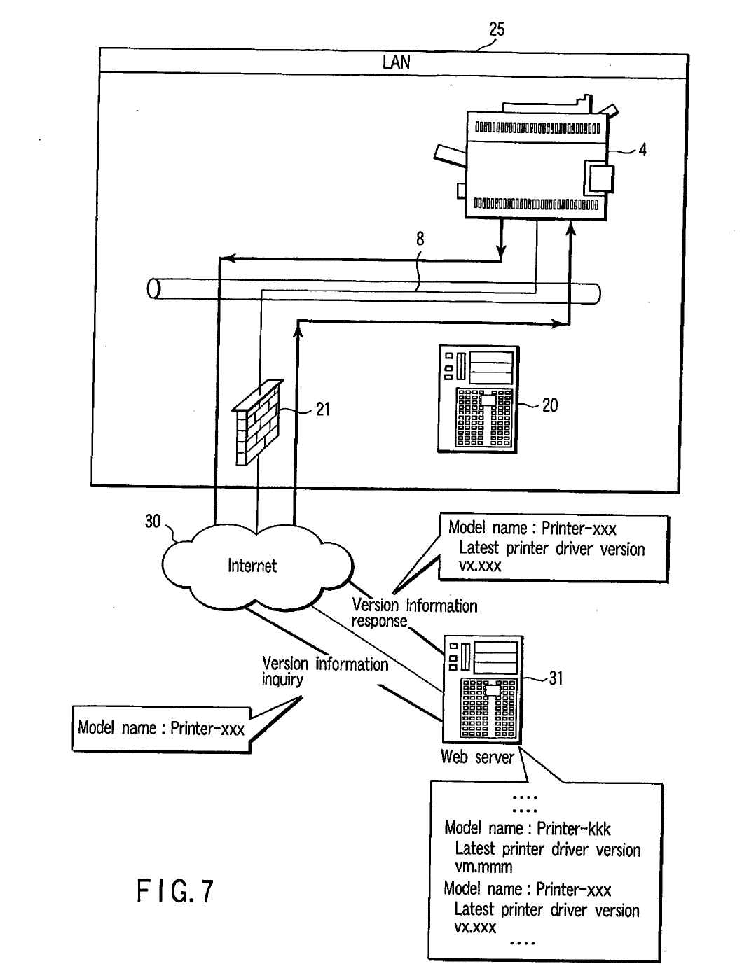

FIG. 7 shows an example of information that is transmitted between the printer 4 and the Web server 31. As is shown in FIG. 7, the CPU 40 of the printer 4 sends an inquiry to the Web server 31 via the bus 8, firewall 21 and Internet 30. The inquiry in this case relates to, e.g. model name: Printer-xxx.

The Web server 31 prestores latest printer driver version information relating to individual model names, for example, a latest printer driver version of model name, Printer-kkk, or a latest printer driver version of Printer-xxx.

Responding to the inquiry from the CPU 40 of the printer 4, the Web server 31 returns version information. For example, the Web server 31 sends the information of the latest printer driver version of Printer-xxx to the printer 4 via the Internet 30, firewall 21 and bus 8.

As has been described above, according to the present embodiment, printer driver versions are compared prior to the printing operation, and the printer driver version is updated, where necessary.

Since the printer driver that is installed in the printer is automatically updated, it is not necessary for the administrator or the user to search for the latest printer driver or to manually install the latest printer driver.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An image forming apparatus that is connected to a plurality of terminal devices via a communication line and forms an image, comprising:
storage means for storing a driver that drives the image forming apparatus, and driver information including version information of the driver;
first control means for executing a control to send the version information of the driver, which is stored in the storage means, to the terminal device, when a version information transmission request that is sent from the terminal device is received; and
second control means for executing a control to send the driver information, which is stored in the storage means, to the terminal device, when an update request is received from the terminal device in accordance with the version information of the driver that is sent by the control of the first control means.

2. An image forming apparatus that forms an image and is connected via a communication line to an upper-level device that includes a latest driver for driving the image forming apparatus and driver information including version information of the latest driver, the apparatus comprising:
storage means for storing a driver that drives the image forming apparatus, and driver information including version information of the driver;
first control means for executing a control to send a latest version information transmission request to the upper-level device at predetermined time intervals;
comparison means for comparing the latest version information, which is transmitted from the upper-level device in response to the transmission request sent by the control of the first control means, and the version information that is stored in the storage means; and
second control means for executing, in a case where the comparison by the comparison means indicates that the latest version information transmitted from the upper-level device is the later one, a control to download the latest driver information from the upper-level device, and to update the driver information stored in the storage means.

3. The image forming apparatus according to claim 2, wherein the predetermined time interval is once a day, once a weak, or once a month.

4. An image forming apparatus that forms an image and is connected via a communication line to a plurality of terminal devices and to an upper-level device that includes a latest driver for driving the image forming apparatus and driver information including version information of the latest driver, the apparatus comprising:
storage means for storing a driver that drives the image forming apparatus, and driver information including version information of the driver;
first control means for executing a control to send a latest version information transmission request to the upper-level device at predetermined time intervals, to compare the latest version information, which is transmitted from the upper-level device, and the version information that is stored in the storage means, to download, in a case where the comparison indicates that the latest version information transmitted from the upper-level device is the later one, the latest driver information from the upper-level device, and to update the driver information stored in the storage means; and
second control means for executing a control to send the version information of the driver, which is stored in the storage means, to the terminal device, when a version information transmission request that is sent from the terminal device is received, and to send the driver information, which is stored in the storage means, to the terminal device, when an update request is received from the terminal device.

5. An image forming apparatus that is connected to a plurality of terminal devices via a communication line and forms an image, comprising:
a memory that stores a driver that drives the image forming apparatus, and driver information including version information of the driver; and
a CPU that executes a control to send the version information of the driver, which is stored in the memory, to the terminal device, when a version information transmission request that is sent from the terminal device is received, and to send the driver information, which is stored in the memory, to the terminal device, when an update request is received from the terminal device.

6. An image forming apparatus that forms an image and is connected via a communication line to a server that includes a latest driver for driving the image forming apparatus and driver information including version information of the latest driver, the apparatus comprising:
a memory that stores a driver that drives the image forming apparatus, and driver information including version information of the driver; and
a CPU that executes a control to send a latest version information transmission request to the server at predetermined time intervals, to compare the latest version information, which is transmitted from the server, and the version information that is stored in the memory, to download, in a case where the comparison indicates that the latest version information transmitted from the server is the later one, the latest driver information from the server, and to update the driver information stored in the memory.

7. An image forming apparatus that forms an image and is connected via a communication line to a plurality of terminal devices and to a server that includes a latest driver for driving the image forming apparatus and driver information including version information of the latest driver, the apparatus comprising:
a memory that stores a driver that drives the image forming apparatus, and driver information including version information of the driver; and
a CPU that executes a control to send a latest version information transmission request to the server at predetermined time intervals, to compare the latest version information, which is transmitted from the server, and the version information that is stored in the memory, to download, in a case where the comparison indicates that the latest version information transmitted from the server is the later one, the latest driver information from the server, and to update the driver information stored in the memory, and
a control to send the version information of the driver, which is stored in the memory, to the terminal device, when a version information transmission request that is sent from the terminal device is received, and to send the driver information, which is stored in the memory, to the terminal device, when an update request is received from the terminal device.

8. An image forming method for an image forming apparatus that is connected to a plurality of terminal devices via a communication line and forms an image, the method comprising:
storing a driver that drives the image forming apparatus, and driver information including version information of the driver;
sending the stored version information of the driver to the terminal device, when a version information transmission request that is sent from the terminal device is received; and
sending the stored driver information to the terminal device, when an update request is received from the terminal device.

9. An image forming method for an image forming apparatus that forms an image and is connected via a communication line to a server that includes a latest driver for driving the image forming apparatus and driver information including version information of the latest driver, the method comprising:
storing a driver that drives the image forming apparatus, and driver information including version information of the driver;
sending a latest version information transmission request to the server at predetermined time intervals, and comparing the latest version information, which is transmitted from the server, and the stored version information; and
downloading, in a case where the comparison indicates that the latest version information transmitted from the server is the later one, the latest driver information from the server, and updating the stored driver information.

10. An image forming method for an image forming apparatus that forms an image and is connected via a communication line to a plurality of terminal devices and to a server that includes a latest driver for driving the image forming apparatus and driver information including version information of the latest driver, the method comprising:
storing a driver that drives the image forming apparatus, and driver information including version information of the driver;
sending a latest version information transmission request to the server at predetermined time intervals, and comparing the latest version information, which is transmitted from the server, and the stored version information;
downloading, in a case where the comparison indicates that the latest version information transmitted from the server is the later one, the latest driver information from the server, and updating the stored driver information;
sending the stored version information of the driver to the terminal device, when a version information transmission request that is sent from the terminal device is received; and
sending the stored driver information to the terminal device, when an update request is received from the terminal device.
